(19) United States
(12) Patent Application Publication
(10) Pub. No.: US 2018/0145392 A1
(43) Pub. Date: May 24, 2018

(54) WAVEGUIDE CONSTRUCTION FOR A GUIDED WAVE RADAR LEVEL TRANSMITTER

(71) Applicant: Honeywell International Inc., Morris Plains, NJ (US)

(72) Inventors: Stuart James Heath, Surrey (CA); Michael Kon Yew Hughes, Vancouver (CA); Sebastien Tixier, North Vancouver (CA)

(21) Appl. No.: 15/358,516

(22) Filed: Nov. 22, 2016

(51) Int. Cl. H01P 3/10; G01F 23/284; G01S 7/282

(52) U.S. Cl. CPC H01P 3/10; G01S 7/282; G01F 23/284

(57) ABSTRACT

A waveguide apparatus for a guided wave radar level transmitter. The waveguide apparatus includes a compacted strand wire rope composed of a group of strands that are compacted and arranged in an outer diameter around a central strand. The compacted strand wire rope for use as a waveguide is configured with a process step of running the strands through a die or rollers to cold work the outer diameter which crushes the wire rope into a smaller cross-section to form the compacted strand wire rope.

### TECHNICAL FIELD

Embodiments are related to waveguides of guided wave radar level transmitters. Embodiments are also related to guided wave radar devices, systems, and methods for measuring the product level in storage tanks.

### BACKGROUND

Processing facilities and other facilities routinely include tanks for storing liquid and other materials. For example, storage tanks are routinely used in tank farms and other storage facilities to store oil or other materials. As another example, oil tankers and other transport vessels routinely include numerous tanks storing oil or other materials. Processing facilities also include tanks for implementing an industrial process, such as receiving material through an input of the tank while allowing material to leave through an output of the tank (e.g., in oil refining operations or chemical production).

Often times, it is necessary or desirable to measure the amount of material stored in a tank, for example, in order to control the level of material in the tank to be at a desired level during an industrial process of receiving or releasing material in the tank. Radar gauges can be used to measure an amount of material stored in a tank. Radar gauges transmit signals towards a material in a tank and receive signals reflected off the material in the tank.

Microwave level gauge or radar level gauge systems are in wide use for determining the fill level of a product contained in a tank. Radar level gauging is generally performed either by means of non-contact measurement, whereby electromagnetic signals are transmitted using a “free space” mode without a guide towards the product contained in the tank or by means of contact measurement, often referred to as guided wave radar (GWR), whereby electromagnetic signals are guided towards and into the product by a probe acting as a guided wave transmission line.

Such a probe is generally arranged to extend vertically from the top towards the bottom of the tank. The probe may also be arranged in a measurement tube, a so-called chamber, which is connected to the outer wall of the tank and is in fluid connection with the inside of the tank. Typically, the probe extends from a transmitter/receiver assembly into the product inside the tank, or chamber, via a sealing arrangement which may form a hermetic barrier.

The most common type of guided wave radar uses short pulses (around 1 ns) without carrier and occupies a frequency range of roughly 0.1-1 GHz.

GWR is commonly used in the process industry to measure the product level in such tanks. GWR uses time domain reflectometry to measure the distance to the product. In GWR measurement systems, a waveguide is used to direct a short (e.g., ˜1 ns) EM pulse towards the surface of the medium in the tank. For deep tanks (e.g., >6 m), stainless steel wire rope can be employed as a waveguide.

There are numerous construction types for commonly available wire rope. These include, for example, 7×7, 7×19, and 1×19, which are respectively shown in FIG. 1 in the wire rope configurations 14, 20, and 10. The configuration 10 is shown in FIG. 1 with a cutaway perspective view 12 and front view 13. The configuration 14 shown in FIG. 1 includes a cutaway perspective view 16 and front view 18, and the configuration 20 shown in FIG. 1 includes a cutaway perspective view 22 and front view 24. These constructions differ in the size and number of individual constituent strands, pitch of twist, and the way they are twisted together (e.g., the number of layers or self-similar layouts). In all, there are hundreds of wire rope construction types for many different applications.

The constructions with multiple smaller strands tend to be more flexible, but are also weaker in tension and more prone to ingress of material. The coarser constructions tend to have a smoother outer surface and a higher load limit. Some conventional configurations utilize a 1×19 wire rope construction as a waveguide for GWR.

The present inventors have found that the different rope constructions also exhibit different propagation properties including, propagation velocity and attenuation coefficient. An alternate smooth and strong cable is sought with good propagation properties.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved waveguide apparatus.

It is another aspect of the disclosed embodiments to provide for an improved waveguide construction for a guided wave radar level transmitter.

It is also an aspect of the disclosed embodiments to provide a waveguide apparatus that includes a compacted strand wire rope based on a compacted strand construction.

The aforementioned aspects and other objectives and advantages can now be achieved as described herein. A waveguide apparatus for a guided wave radar level transmitter is disclosed. The waveguide apparatus includes a compacted strand wire rope composed of a group of strands that are compacted and arranged in an outer diameter around a central strand. The compacted strand wire rope for use as a waveguide is configured with a process step of running the strands through a die or rollers to cold work the outer diameter which crushes the wire rope into a smaller cross-section to form the compacted strand wire rope.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates cutaway perspectives and front views of example prior art construction types for commonly available wire rope or cable, in accordance with an example embodiment;

FIG. 2 illustrates cross-section views of a wire rope or cable having a compacted strand construction (28) versus a wire rope having a non-compacted strand construction (26) with the compacted construction implemented in accordance with an example embodiment;

FIG. 3 illustrates a front view of a wire rope or cable having a 1×7 compacted strand construction in accordance with an example embodiment; and

FIG. 4 illustrates a front view of a wire rope or cable having a 1×19 compacted strand construction in accordance with an example embodiment.

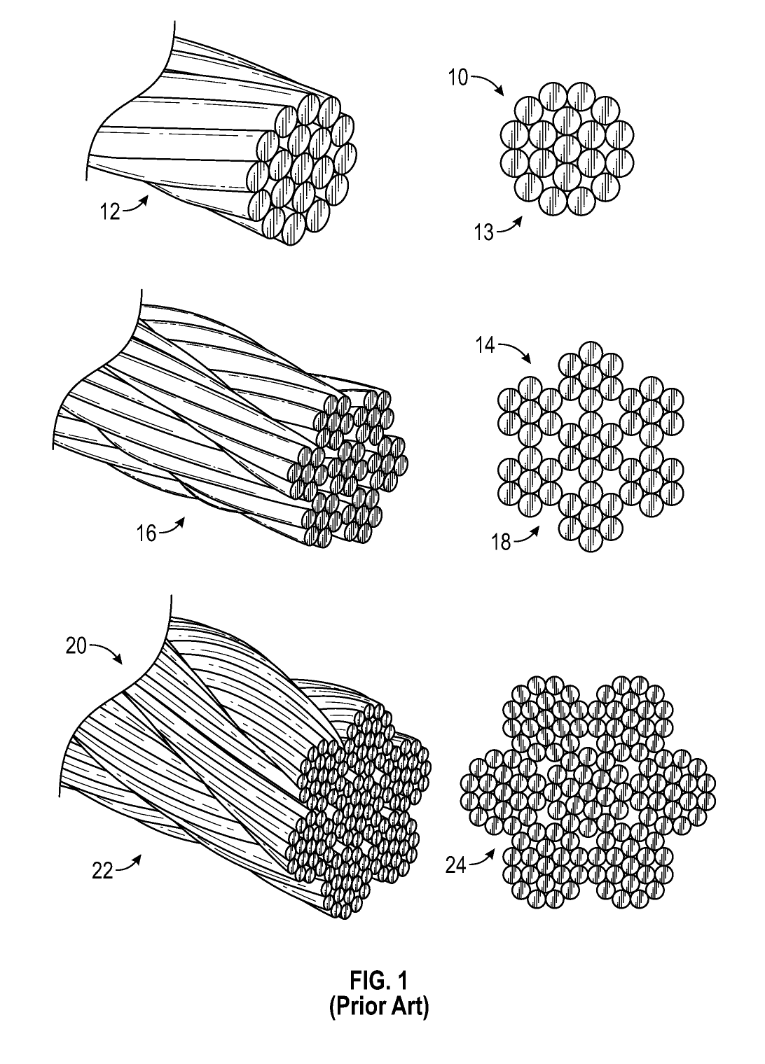

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout. As used herein, the term “and/or” includes any and all combinations of one or more of the associated listed items.

Subject matter may be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is not, therefore, intended to be interpreted in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. The term “at least one” can also refer “one or more”.

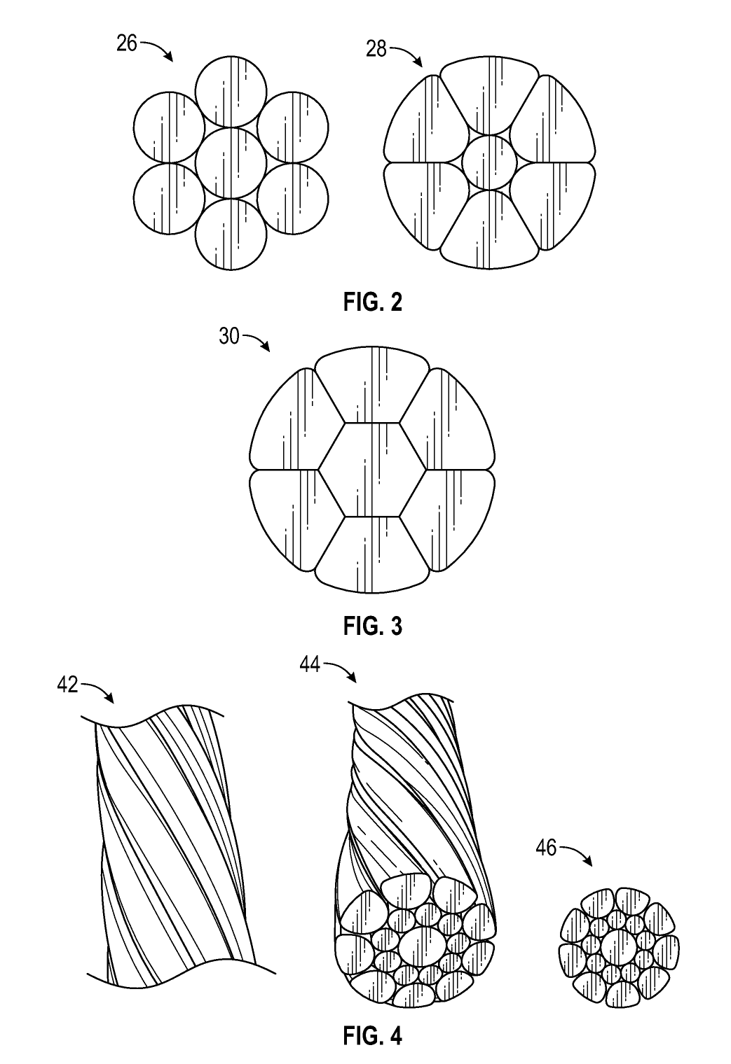

FIG. 2 illustrates cross-section views of a wire rope 28 having a compacted strand construction versus a wire rope 26 having a non-compacted strand construction with the compacted construction implemented in accordance with an example embodiment. The construction of the wire rope 28 is based on a compacted strand construction. The compacting of strands is a cold deformation process, which involves reducing the diameter of the strand and its wires by passing through a die or a rollers pair. This process generates profound changes in the shape of the wires including increasing the metallic cross-section fraction of the strand, extending the areas of contact between the wires, making the surface of the strand smoother and more regular and therefore less permeable, distributing more uniformly the tension on the wires, and finally making the strand more stable with respect to the transversal forces. The advantages resulting from the compaction allows the use of ropes with compacted strands in all sectors and in particular in those applications where high stresses are found and where they requires a high load capacity.

FIG. 3 illustrates a cross-section view of a wire rope or cable 30 having a 1×7 compacted strand construction in accordance with an example embodiment. FIG. 4 illustrates a front view of a wire rope or cable 46 having a 1×19 compacted strand construction in accordance with another example embodiment. Both the wire rope/cable 30 and the wire rope/cable 46 can be utilized as waveguides in the context of a GWR level transmitter. FIG. 4 additionally depicts detailed images 42 and 44 of the wire rope/cable 46.

Compacted strand wire rope construction is a type of rope construction that receives an additional process step of being run through a die or rollers to cold work the outer diameter. This crushes the rope into a smaller cross-section. The process tends to fill in the air gaps and makes the outer surface smoother. Due to the cold work, compacted strand wire rope also exhibits a higher load limit for a given rope diameter. The main advantage of compacted strand rope construction for use as a waveguide in GWR is the smoother outer surface.

The condition of the surface of the waveguide also has implications on the speed of propagation and attenuation of the pulse. The smoother surface has advantages in lower attenuation and higher propagation speed. The smoother surface would also have the advantage of being less prone to buildup on the probe surface, leading to erroneous echoes. Less space between strands and tighter compaction can also assist in rendering the cable more impervious to material ingress, which could physically degrade the cable (e.g., cause fraying) or even alter the propagation parameters and lead to measurement error. Also important to consider is the reduction in variability of propagation velocity.

The early Goubau line papers describe surface wave propagation on a wire waveguide and refer to “surface modification” having influence on the extension of the field around the waveguide. This surface modification refers to the condition of the surface of the waveguide, be it “threaded” or “coated” in a dielectric material.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A waveguide apparatus for a guided wave radar level transmitter, comprising:
a compacted strand wire rope comprising a plurality of strands that are compacted and arranged in an outer diameter around a central strand, said plurality of strands including said central strand.

2. The apparatus of claim 1 wherein said compacted strand wire rope is configured with a process step of running said plurality of strands through a die or rollers to cold work said outer diameter which crushes a wire rope thereof into a smaller cross-section to form said compacted strand wire rope.

3. The apparatus of claim 2 wherein air gaps within said wire rope are filled in as a part of said process step.

4. The apparatus of claim 2 wherein said compacted strand wire rope comprises a smooth outer surface as a result of said process step.

5. The apparatus of claim 2 wherein said compacted strand wire rope comprises a high load limit for a given rope diameter due to said cold work.

6. The apparatus of claim 1 wherein said compacted strand wire rope comprises a 1×7 compacted strand construction.

7. The apparatus of claim 1 wherein said compacted strand wire rope comprises a 1×19 compacted strand construction.

8. The apparatus of claim 1 wherein said compacted strand wire rope comprises a cable that comprises the waveguide of said guided wave radar level transmitter.

9. A waveguide apparatus for a guided wave radar level transmitter, comprising:
a compacted strand wire rope comprising a plurality of strands that are compacted and arranged in an outer diameter around a central strand, said plurality of strands including said central strand and wherein said compacted strand wire rope is configured with a process step of running said plurality of strands through a die or rollers to cold work said outer diameter which crushes a wire rope thereof into a smaller cross-section to form said compacted strand wire rope.

10. The apparatus of claim 9 wherein air gaps within said wire rope are filled in as a part of said process step.

11. The apparatus of claim 9 wherein said compacted strand wire rope comprises a smooth outer surface as a result of said process step.

12. The apparatus of claim 9 wherein said compacted strand wire rope comprises a high load limit for a given rope diameter due to said cold work.

13. The apparatus of claim 9 wherein air gaps within said wire rope are filled in as a part of said process step and wherein said compacted strand wire rope comprises a smooth outer surface as a result of said process step.

14. The apparatus of claim 9 wherein air gaps within said wire rope are filled in as a part of said process step and wherein said compacted strand wire rope comprises a smooth outer surface as a result of said process step and wherein said compacted strand wire rope comprises a high load limit for a given rope diameter due to said cold work.

15. A method of configuring a waveguide apparatus for a guided wave radar level transmitter, said method comprising:
forming a compacted strand wire rope comprising a plurality of strands that are compacted and arranged in an outer diameter around a central strand, said plurality of strands including said central strand.

16. The method of claim 15 further comprising configuring said compacted strand wire rope with a process step of running said plurality of strands through a die or rollers to cold work said outer diameter which crushes a wire rope thereof into a smaller cross-section to form said compacted strand wire rope.

17. The method of claim 16 wherein air gaps within said wire rope are filled in as a part of said process step.

18. The method of claim 16 wherein said compacted strand wire rope comprises a smooth outer surface as a result of said process step.

19. The method of claim 15 wherein said compacted strand wire rope comprises a 1×7 compacted strand construction.

20. The method of claim 15 wherein said compacted strand wire rope comprises a 1×19 compacted strand construction.
